(19) United States
(12) Patent Application Publication
(10) Pub. No.: US 2010/0098861 A1
(43) Pub. Date: Apr. 22, 2010

(54) Painting Method of Plastic Parts Reinforced With Carbon Nano Tube

(75) Inventors: Tae Jun Jin, Gyeonggi-Dong (KR); Sang Hoon Lee, Ulsan (KR); Man Sick Son, Ulsan (KR); Hyun Tae Kim, Ulsan (KR); Chun kyun Chung, Daegu (KR); Gyo Jin Chu, Daegu (KR)

Correspondence Address: LAHIVE & COCKFIELD, LLP;FLOOR 30, SUITE 3000, ONE POST OFFICE SQUARE, BOSTON, MA, 02109, US

(73) Assignee: Dae Jin Industrial Co., LTD, Gyeongsangbuk-do (KR)

(21) Appl. No.: 11/989,812

(22) PCT Filed: Jun. 25, 2007
(86) PCT No.: PCT/KR2007/003063

§ 371 Date: Jan. 31, 2008

(30) Foreign Application Priority Data
Oct. 19, 2006 (KR) 10-2006-0101616

(51) Int. Cl. B05D 3/00

(52) U.S. Cl. 427/299

(57) ABSTRACT

Disclosed is a method of coating carbon nanotube-reinforced plastic, which enables higher productivity and cost reduction by omitting one or more steps as compared to a conventional coating process, and which allows a paint film to be superior in adhesion and brilliance. The inventive method includes: a plastic-forming step for forming a plastic article to be coated from a plastic material mixed with a minute quantity of nanotubes; a pre-treatment step for removing oil-fat and foreign matters from the plastic article; and a surface coat coating step for coating the plastic article with paint directly on the surface of the plastic article so as to protect the plastic article.

### TECHNICAL FIELD

The present invention relates to a method of coating carbon nanotube-reinforced plastic, and more particularly to a method of coating carbon nanotube-reinforced plastic, which enables higher productivity and cost reduction by omitting some steps as compared to a conventional coating process, and which allows a coating film to be superior in adhesion and brilliance.

### BACKGROUND ART

In general, various kinds of coated plastic articles, which are obtained by coating various kinds of plastic bases with various synthetic resin paints, are produced in large quantities in various fields and are widely used. In particular, plastic becomes more and more important in the fields of manufacturing automobiles, freight cars, and district cars.

The term, “plastic” is used to refer to all kinds of highly polymerized compounds capable of being molded by being plastically deformed under heat and/or pressure, wherein plastic materials are classified into natural resin and synthetic resin. However, the term plastic is usually used to refer to synthetic resin.

Typically used plastic materials include polypropylene, polyester, epoxy, phenol resin, etc. Plastic articles or components formed from these plastic materials are advantageous in that they are strong, light, and rustproof.

Despite these good physical and chemical properties, plastic materials have disadvantages in that they are chemically inactive because they do not have polar groups and functional groups in their molecules, and they are poor in adhesive property in a coating process because they are not very soluble in solvent.

In particular, multilayer coating systems are employed in the automobile industry. Therefore, it is needed to select paints excellent in adhesive property because an interlayer adhesive property between the primer coat and the middle or top coat applied to the top of the primer coat is very important in such a multilayer coating system.

In addition, plastic materials are apt to be electrostatically charged. If a surface of a plastic article coated with paint is electrostatically charged, dusts may be excessively adhered to the surface. Therefore, various surface treatment methods are attempted so as to improve the paintability and anti-static property of plastic materials.

FIG. 1 is a flowchart for describing a conventional plastic coating process.

As shown in FIG. 1, the conventional plastic coating process is comprised of four basic steps: a pre-treatment step, a primer coating step, a middle coat coating step, and a top coat coating step.

The pre-treatment step includes steps of: chemically and physically flattening a surface so as to make the condition of the surface even; treating the surface to form fine holes on the surface so as to improve the adhesion between the surface and a primer coat; and removing fat, grease, or oil (hereinafter, to be referred to as “oil-fat”) from the surface or removing foreign matters produced during the step of flattening the surface and contaminants attached to the coated surface, by using isopropyl alcohol or alkaline oil-fat remover. Thereafter, a drying step is conducted, and then a primary preparation step for mounting the article to be coated with paint on a jig is conducted in preparation of the primer coating step.

The primer coating step is a step for increasing the adhesive property at the time of coating in the middle coat and top coat coating steps and for flattening the surface of the article coated with paint. Thereafter, a primary coating inspection step for inspecting the coated state is conducted, and then a secondary preparation step is conducted, in which step the article coated with paint is dried, contaminants are removed from the surface of article coated with paint, and the article coated with paint is mounted on a jig in preparation of the middle coat coating step.

The middle coat coating step is a step for coating an article with color paint. When coating an interior or exterior material of an automobile with paint, the aesthetic appearance of which is regarded as of great importance, organic solvent-diluted thermosetting paints are frequently used so as to form a coating excellent in flatness, image clarity, and weatherproofing. Thereafter, a secondary coating inspection step for inspecting the coated states is conducted, and then a third preparation step is conducted, in which step the article coated with paint is dried, contaminants are removed from the surface of article coated with paint, and the article coated with paint is mounted on a jig in preparation of the top coat coating step.

The top coat coating step is performed so as to protect the paint coating formed in the primer and middle coat coating steps. For example, it is possible to employ a method of coating an organic solvent-diluted thermosetting transparent clear paint repeatedly, and then simultaneously curing dual layers of coated paint. Thereafter, a third coating inspection step for inspecting the coated state is performed, and then a drying step is performed. If the article coated with paint is rejected in the coating inspection step, it will be wasted or the above-mentioned coating process will be repeatedly performed.

### DISCLOSURE OF INVENTION

### Technical Problem

Because the primer coating step for increasing flatness and the brilliance and adhesion of the coating film, and the middle coat coating step for coloring are essentially required in the above-mentioned conventional coating process, the entire coating process is very complicated and has difficulty in achieving quality control, which in turn renders productivity poor and causes the process cost and material cost to be increased.

Therefore, the present invention has been made in order to solve the above-mentioned problems, and the present invention provides a method of coating carbon nanotube-reinforced plastic, which enables higher productivity and cost reduction by omitting some steps as well as allows a paint film to be superior in adhesion and brilliance.

### Technical Solution

According to an aspect of the present invention, there is provided a method of coating carbon nanotube-reinforced plastic including: a plastic-forming step for forming a plastic article to be coated from a plastic material mixed with a minute quantity of nanotubes; a pre-treatment step for removing oil-fat and foreign matters from the plastic article; and a surface coat coating step for coating the plastic article with paint directly on the surface of the plastic article so as to protect the plastic article.

In addition, the paint in the surface coat coating step is mixed with pigment so as to color the surface of the plastic article.

According to another aspect of the present invention, there is provided a method of coating carbon nanotube-reinforced plastic including: a plastic-forming step for forming a plastic article to be coated from a plastic material mixed with a minute quantity of nanotubes; a pre-treatment step for removing oil-fat and foreign matters from the plastic article; a middle coat coating step for coating the plastic article with pigment-mixed paint so as to color the plastic article; and a surface coat coating step for coating the plastic article with paint directly over the middle coat so as to protect the plastic article.

### Advantageous Effects

According to the inventive method of coating carbon nanotube-reinforced plastic, it is possible to simplify the pre-treatment process in the conventional coating process and to remove the primer and middle coat coating steps or the middle coat coating step from the conventional coating process by mixing carbon nanotubes with a plastic material, which enables higher productivity and cost reduction, as well as allows a paint film to be superior in adhesion and brilliance.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a flowchart for describing a conventional plastic coating process;

FIG. 2 is a flowchart for describing a plastic coating process according to an embodiment of the present invention; and
FIG. 3 is a flowchart for describing a plastic coating process according to another embodiment of the present invention.

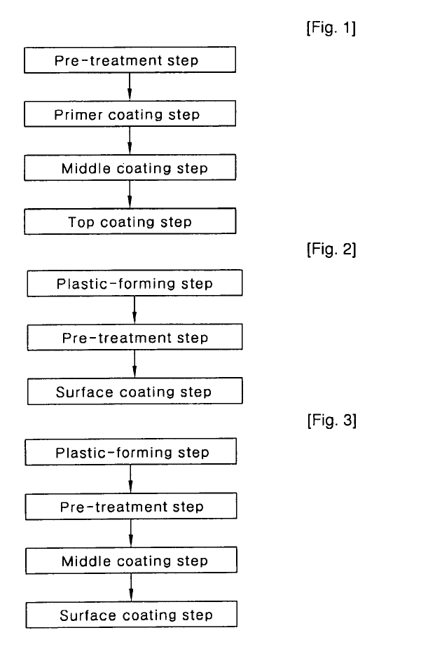

### BEST MODE FOR CARRYING OUT THE INVENTION

Hereinafter, exemplary embodiments of the present invention will be described with reference to the accompanying drawings.

Carbon nanotubes, which have been recently highlighted as an advanced material, are molecular-scale tubes of lamellar graphite with carbon atoms connected in a hexagonal ring structure. The diameter of such carbon nanotubes is in the range of several to scores of nanometers.

Such carbon nanotubes are strong but very flexible. In addition, the carbon nanotubes are not damaged or worn even if they are repeatedly used, and the carbon nanotubes have very wide surface areas as compared to the volumes thereof. Furthermore, the carbon nanotubes are chemically stable and have excellent thermal and electric properties. Due to these properties, the carbon nanotubes are employed in various applications, such as electromagnetic wave absorbents, anti-static agents, field emission devices, semiconductor devices, gas and bio sensors, fuel cells, reinforcements, etc.

FIG. 2 is a flowchart for describing a plastic coating process according to an embodiment of the present invention.

As shown in FIG. 2, the inventive plastic coating process includes a plastic-forming step, a pretreatment step, and a surface coat coating step.

The plastic-forming step is a step of mixing a minute quantity of carbon nanotubes with a plastic material and molding the mixture into a plastic article to be coated. Therefore, the method of coating carbon nanotube-reinforced plastic can simplify the existing coating process by incorporating a minute quantity of carbon nanotube into plastic so as to improve the brilliance and adhesive property of a paint film.

Molded plastic articles produced through any molding process, such as injection molding, extrusion molding, and press molding, may be employed in the present invention. Such plastic articles include daily necessaries, containers, machine parts, automobile parts, pipes, etc.

The pre-treatment step is a step for removing oil-fat and/or foreign matters. For example, oil-fat is removed with alcohol or alkali oil-fat remover from an article to be coated with paint (i.e., a plastic molded article). Therefore, drying is performed, and then a preparation step of mounting the article on a jig is performed in preparation of a surface coat coating step.

The surface coat coating step is a step for applying paint directly on the surface of the article for the purpose of protecting the article. Because the adhesive property of the paint is increased due to the carbon nanotubes mixed in the plastic molded article itself, it is possible to omit the primer coating step which is essential in the conventional coating technique.

In more particular, because carbon nanotubes are mixed in the article to be coated with paint, and the carbon nanotubes are partially exposed on the surface of the article, so that the carbon nanotubes serve as nanoscale strong supports, the adhesion between the paint and the article becomes excellent. In addition, as carbon nanotubes are superior in brilliance as compared to existing graphite and carbon black, and evenly distributed in nanoscale within the article to be coated with paint, the surface brilliance of the article coated with paint becomes more excellent as compared to that coated with micro-scale black pigment.

According to another embodiment of the present invention, the paint is preferably mixed with pigment, thereby being colored, in the surface coat coating step. The pigment may be selected from graphite, carbon black, and carbon nanotubes, besides ordinary color pigment. Therefore, it is possible to select and use various colors when coating an interior or exterior material for an automobile, the aesthetic appearance of which is regarded as of great importance.

Powdered coating composition capable of being employed in the present invention may be any powdered coating composition well known in the art, such as thermosetting powdered coating composition. For example, the powdered coating composition may be powdered epoxy resin paint, powdered polyester paint, powdered acryl resin paint, or the like.

FIG. 3 is a flowchart for describing a plastic coating process according to another embodiment of the present invention.

As shown in FIG. 3, the method of coating carbon nanotube-reinforce plastic includes a plastic-forming step, a pre-treatment step, a middle coat coating step, and a surface coat coating step.

The plastic-forming step is a step of mixing a minute quantity of carbon nanotubes with a plastic material and molding the mixture into a plastic article to be coated with paint. Therefore, the method of coating carbon nanotube-reinforced plastic according to the present embodiment can also simplify the existing coating process by incorporating a minute quantity of carbon nanotube into plastic so as to improve the brilliance and adhesive property of a paint film.

The pre-treatment step is a step for removing oil-fat and/or foreign matters. For example, oil-fat is removed with alcohol or alkali oil-fat remover from an article to be coated with paint (i.e., a plastic molded article), then drying is performed, and then a preparation step of mounting the article on a jig is performed in preparation of a surface coat coating step.

The middle coat coating step is a step of coating the plastic article with pigment-mixed paint, thereby coloring the plastic article. Because the pigment-mixed paint is coated in this step, it is possible to select and use various colors when an interior or exterior material of an automobile, the aesthetic appearance of which is regarded as of great importance.

The surface coat coating step is a step of coating paint so as to protect the pigment-mixed paint and the plastic article.

Various paints including two-component urethane paint, one-component alkid-melamine paint, and one-component acryl paint may be used in the surface coat coating step of the present invention.

The present invention is not limited to the kind of plastic materials, and to the shape, diameter, and length of carbon nanotubes. In addition, 0.1 to 10 weight parts of carbon nanotubes are preferably mixed with 100 weight parts of plastic. If so, the surface resistivity a coated plastic article has a surface resitivity, which is not higher than 10¹²ohm-cm, so that dusts are prevented from being attached to the surface.

Although several exemplary embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention can be applied to various plastic materials employed in the fields of automobiles, freight cars, and district cars.

1. A method of coating carbon nanotube-reinforced plastic comprising:
a plastic-forming step for forming a plastic article to be coated from a plastic material mixed with a minute quantity of nanotubes;
a pre-treatment step for removing oil-fat and foreign matters from the plastic article; and
a surface coat coating step for coating the plastic article with paint directly on the surface of the plastic article so as to protect the plastic article.

2. The method as claimed in claim 1, wherein the paint in the surface coat coating step is mixed with pigment.

3. A method of coating carbon nanotube-reinforced plastic comprising:
a plastic-forming step for forming a plastic article to be coated from a plastic material mixed with a minute quantity of nanotubes;
a pre-treatment step for removing oil-fat and foreign matters from the plastic article;
a middle coat coating step for coating the plastic article with pigment-mixed paint so as to color the plastic article; and
a surface coat coating step for coating the plastic article with paint directly over the middle coat so as to protect the plastic article.
